(19) United States
(12) Patent Application Publication
(10) Pub. No.: US 2010/0162285 A1
(43) Pub. Date: Jun. 24, 2010

(54) Presence Detector and Method for Estimating an Audience

(76) Inventors: Yossef Gerard Cohen, Rosh Haayin (IL); Eliahu Elson, Ramat Gan (IL)

Correspondence Address: The Law Office of Michael E. Kondoudis, 888 16th Street, N.W., Suite 800, Washington, DC, 20006, US

(21) Appl. No.: 12/719,131

(22) Filed: Mar. 8, 2010

Related U.S. Application Data
(63) Continuation-in-part of application No. PCT/IL2008/001218, filed on Sep. 11, 2008.
(60) Provisional application No. 60/971,492, filed on Sep. 11, 2007.

(51) Int. Cl. H04H 60/33; G08B 23/00

(52) U.S. Cl. 725/12; 340/573.1

(57) ABSTRACT

A presence detector for detecting and estimating an audience watching television comprising: one or more presence sensors adapted to capturing signals emitted by or reflected from the audience; and a translator connected to the one or more presence sensors adapted to translating output signals created by the one or more presence sensors to data signals representing the estimated number of people in the audience. Presence information captured is converted to television rating data and is very useful for pricing advertisements accurately.

### CROSS-REFERENCE TO RELATED APPLICATIONS

This application is a National Stage and Continuation-In-Part of International Application No. PCT/IL2008/001218, filed Sep. 11, 2008, which claims the benefit of priority from U.S. Provisional Patent Application No. 60/971,492 filed Sep. 11, 2007 and from U.S. Provisional Patent Application No. 61/087,949 filed Aug. 11, 2008.

### FIELD OF THE INVENTION

The present invention relates to a presence detector and method for detecting and estimating an audience, and in particular for estimating an audience watching television.

### BACKGROUND OF THE INVENTION

Measuring an audience precisely is a question of great economic importance especially in areas such as television programs, advertisement (across all media), movie films, outdoor advertisements, malls and shops etc. For example, the more people watch a television program, the higher the price the content provider can charge the program broadcaster, and the higher the price the broadcaster can charge for advertisement with that television program. The more people visit a mall or a shopping center, the higher the price the mall operator can charge for store rent. The number of people determined to watch a television program will also determine if the program is continued or should be replaced.

Television ratings are typically performed by measuring a representative sample. In the United States, for example, Nielsen Media Research samples more than 10,000 voluntary households, out of the about 99 million households with TVs in the U.S. (all information concerning Nielsen Media Research here and below is provided by Nielsen on their United States Internet site: http://www.nielsenmedia.com).

It is not only important to measure what program the television is displaying but also who and how many people (or “eyeballs” in the terms of the advertisement industry) are watching the program at a specific moment. Current people measuring devices also referred to as “peoplemeter's”, use a voluntary system where each participating person has to actively signal when he's starting and finishing watching a program. Nielsen Media Research uses a dedicated device which each rating participant has to press when he starts and finishes watching television (a remote control is also available).

Another method used by Nielsen Media Research is to ask people to maintain diaries where they note what each person is watching in 15-minute periods. The diaries are then mailed back to Nielsen Media Research every quarter for analysis.

Yet another method used in the art for measuring television audiences is conducting telephone polls relying on people's good memory and faith.

Naturally, all these voluntary people measuring systems have numerous inconveniences and limitations. A person may forget to press the button at times or a person may not press the button when leaving the room for a short break for example when going to the kitchen or the toilette at a commercial break. A person might expressively avoid pressing the button in order to not be identified as watching certain content, for example adult content. The voluntary peoplemeter cannot be used in places like sports bars where a large and irregular audience may be watching specific events.

It is thus very desirable to develop a solution for accurately measuring the number of people watching a program in an automatic and independent way without requiring any act or action from these people.

General methods of counting people are known in the art, for example, methods based on image processing algorithms. US Patent Application 2006/0062429 suggests a method for detecting motion in the image and comparing two images take at different subsequent times. Applying an image processing algorithm determines if at least one shape represents a person. US Patent Application 2006/0200841 suggests a method of identifying people in an image by identifying human-like shapes in a captured image. These types of methods image processing have several disadvantages: they are expensive to implement and requires substantial processing power.

Traditionally, the television set has been used mainly for watching television programs received over the air, via cable or satellite. With the convergence of the Internet and the television, more and more solutions are proposed for using the television as a mean for accessing both television programs and content through the Internet, sometimes simultaneously. For example, an advertisement might demonstrate a product with the possibility of purchasing the product via an Internet connection from the same screen. Another convergence scenario is when an Internet connection provides more data or an advertisement related to the content of the television program watched, for example, while watching a sports event the viewer may request more information about the track record of a team or a player or receive advertisements for sports-related material.

Currently, advertisement in the Internet is typically measured per user click or exposure and always assumes that a single user is watching the computer screen. If Internet content and advertisement are watched on television in the living room, it would be highly desirable to estimate how many people are watching the television set in order to price the advertisement accordingly. The person who is supposed to watch an advertisement on television may be sleeping, talking on the phone, reading a newspaper, eating or not in front of the TV at all.

The human body radiates electromagnetic radiation in the optical part of the spectrum (broadly speaking, infrared radiation is also included). All objects also radiate electromagnetic radiation but the emission intensity and radiation frequency depends on the temperature, emissivity and area of the object or body, so they can be separated when trying to detect a person.

The main part of the emission spectrum of the human body assuming its temperature is at 37° C., is within the spectrum range 5-20 μm (microns), as is shown in FIG. 1. So when using an infrared (IR) detector, it is desirable to filter the incoming radiation within this spectral range so other radiation sources are blocked or at least diminished.

Electrical devices, such as television sets, consume electricity. It does not make much sense to leave a television set turned on for a long period of time if nobody is there to watch. Thus it is desirable to be able to turn off an electric device (television set, air-conditioning unit etc.) automatically if it is determined that nobody is in the room for a given period of time.

### SUMMARY OF THE INVENTION

It is an object of the present invention to provide a presence detector for detecting an audience.

It is another object of the present invention to provide a presence detector for detecting an audience in front of a television.

It is another object of the present invention to provide a presence detector for estimating the number of people watching or sitting in front of a television.

It is yet another object of the present invention to detect an audience watching television in a given location by capturing the electromagnetic radiation emitted by the human body using detectors such as Pyroelectric, thermopiles, acoustic sensors etc.

It is yet another object of the present invention to estimate the number of people present watching television in a given location by capturing the electromagnetic radiation emitted by the human body using a pyroelectric detector even when the people are at rest.

It is yet another object of the present invention to provide rating data for television programs and advertisements.

It is yet another object of the present invention to provide detection when an audience is present in front of a television and select an advertisement to be displayed on the television only when an audience is detected.

By estimating the number of people present in a location it can provide also the information that if nobody is in front the television then the television can be turned off automatically by the presence detector. The same concept of detecting a presence can be used to turn on or off other devices such as lighting systems, air conditioning units, automatic gates etc.

In one aspect the present invention relates to a presence detector for detecting an audience, comprising:

a plurality of pyroelectric detectors for capturing thermal signals emitted by the audience;

a plurality of lenses, wherein each lens is positioned in front of a pyroelectric detector; and

one or more microprocessors connected to the plurality of pyroelectric sensors for translating thermal signals created by the plurality of pyroelectric detectors to data signals representing the estimated number of people in the audience.

In certain embodiments, the line of sight of the plurality of pyroelectric detectors is directed toward the upper part of a person's body, at a height of about one meter above the ground.

In certain embodiments, the field of view of each pyroelectric detector is between 10 and 20 degrees.

In certain embodiments, the plurality of lenses are diffractive lenses.

In certain embodiments, each lens of the plurality of lenses has a diameter of about 8 mm.

In another aspect, the present invention thus relates to a presence detector for detecting and estimating an audience watching television, comprising:
one or more presence sensors adapted to capturing signals emitted by or reflected from the audience; and
a translator connected to said one or more presence sensors adapted to translating output signals created by the one or more presence sensors to data signals representing the estimated number of people in the audience.

In certain embodiments, the present detector further comprises a communications port for communicating the estimated number of people to a remote facility. The remote facility can further process the received data, and can also decide on the appropriate action to take based on the information received.

In certain embodiments, the content displayed on the television is detected by the presence detector.

In certain embodiments, the content displayed on the television is selected according to the estimated number of people detected in the audience.

In certain embodiments, the selected content displayed on the television, based on the estimated number of people in the audience, is advertising.

The presence detector of the invention can be placed in a representative sample of television households. Rating data can be gathered and analyzed to determine the pricing of advertisings in different programming slots. The return on investment of a television advertisement can also be calculated according to the audience detected by the presence detector.

In certain embodiments, an audience is measured before during and after an advertisement is displayed on television in order to accurately estimate the audience during the advertisement break.

In certain embodiments, the television's screen is turned off after no audience is detected for predetermined period of time.

Similarly, other electrical devices, such as an air conditioning unit, can also be turned off after no audience is detected for a predetermined period of time.

The presence detector of the invention can use any available presence sensors such as a pyroelectric detector, an ultrasonic transceiver, a thermopile sensor, an imaging camera, an imaging camera with a VMD algorithm, an imaging camera with a face detection algorithm, a photodiode, IR receiver, a microphone, or an electro-optic detector coupled to a light source.

The thermopile sensor used may comprise a single thermopile sensor, a line of thermopile sensors or a matrix of thermopile sensors.

In certain embodiments, the photodiode or IR receiver detects signals emitted from any remote control operated by the audience.

Alternatively, a microphone can be used by the presence detector in order to detect sound voices from the audience.

The signals emitted by or reflected from the audience comprise sound signals, infrared signals, electromagnetic signals or optical signals.

A separate presence detector of the invention can be installed as an independent component which is located in front of the viewers for example on the TV, or integrated into a set-top box or even integrated into the television set. The device of the invention may also be used to measure students in a classroom, people entering a mall, people waiting in line for a service etc.

Television advertisements can be more accurately priced according to the estimation of number of people actually present in front of the television. In addition, the proposed device can be used for rating the advertisements themselves since the metering by the presence detector can be continuous and communicated online.

In another aspect, the presence invention relates to a method for detecting and estimating an audience watching television, comprising the steps of:
capturing signals emitted by or reflected from the audience by a presence sensor; and
translating said captured signals to a data signals representing the estimated number of people in the audience.

In yet another aspect, the present invention relates to an advertising method for sending commercial advertisements to an audience in front of a television set, the method comprising the steps of: (i) detecting the presence of at least one viewer in front of said television set using the presence detector of the invention; and (ii) sending an advertisement to the television set only when the at least one viewer is detected. It is thus possible to guarantee to an advertiser that its advertisement has actually been broadcast to an existing audience, as opposed to the current situation when an advertisement is placed in the middle of a program, but the audience may leave the room or simply change channels at the commercial break.

In certain embodiments, the presence detector comprises an electronic circuit that finds out if the television is turned on. In certain embodiments, the electronic circuit compares and correlates the audio signal entering a television set with the audio signal entering a microphone coupled to the presence sensor. Alternatively, the electronic circuit is an electromagnetic loop or a photodiode directed to the television's screen or a current sensor coupled to the presence sensor.

In certain embodiments, the presence detector of the invention further comprises:

a mirror;

a slit;

a filter; and

a rotating motor.

The mirror is adapted to rotate in order to scan a large field of view. Alternatively, instead of using a mirror it is possible to rotate instead the presence sensor. Both the mirror and the filter are optional and may not be used. The mirror is coated on both sides with high reflection coating for the mid-IR spectrum from 4 micron to 20 micron. In certain embodiments, the filter only passes signals between 5 micron and 20 micron.

In certain embodiments, the presence detector integrates energy-saving capabilities to turn off the television set when nobody is watching it. In one implementation, the presence detector contains four modules that may be located on one board:

1) IR module—has the ability to learn IR signals from remote control.
2) Presence Sensors Module—for example, pyroelectric, thermopiles, ultrasonic sensors, microphones etc.
3) Control module—responsible for reading presence sensors, running a state machine, and turning on the IR module for turning off the television
4) TV status module—determines if the television is on or off

There are many ways to determine if the television is on or off. A photodiode that is looking on the TV screen can identify if there is light above a predetermined threshold from the screen thus deducting that the TV is on. Alternatively, one can sample the audio in signal to the television and using a microphone coupled to the presence detector compare the two audio signals. If a correlation is found between the two signals, than it can be deducted that the TV is on (this solution will not work if the television sound is muted). Another option is to sample the current that enters the TV, when the TV is on than the current is much higher than when the TV is off. It can be done also by a magnetic loop.

### BRIEF DESCRIPTION OF THE DRAWINGS

FIG. 1 is a graph of the radiant emittance of a human being at 37 degree Celsius.

FIG. 2 is an illustration of a presence detector device of the invention.

FIG. 3 is an example of a graph of the signal vs. instantaneous field of view (IFOV) when the presence detector is in operation.

FIG. 4 illustrates an embodiment of a presence detector device comprising multiple presence sensors with equal field of view (FOV).

FIG. 5 illustrates an embodiment of a presence detector device comprising multiple presence sensors with variable size field of views (FOV).

FIG. 6 illustrates an embodiment of a presence detector device comprising four pyroelectric detectors.

FIG. 7 is a block diagram of a module to turn off a television automatically when nobody is watching.

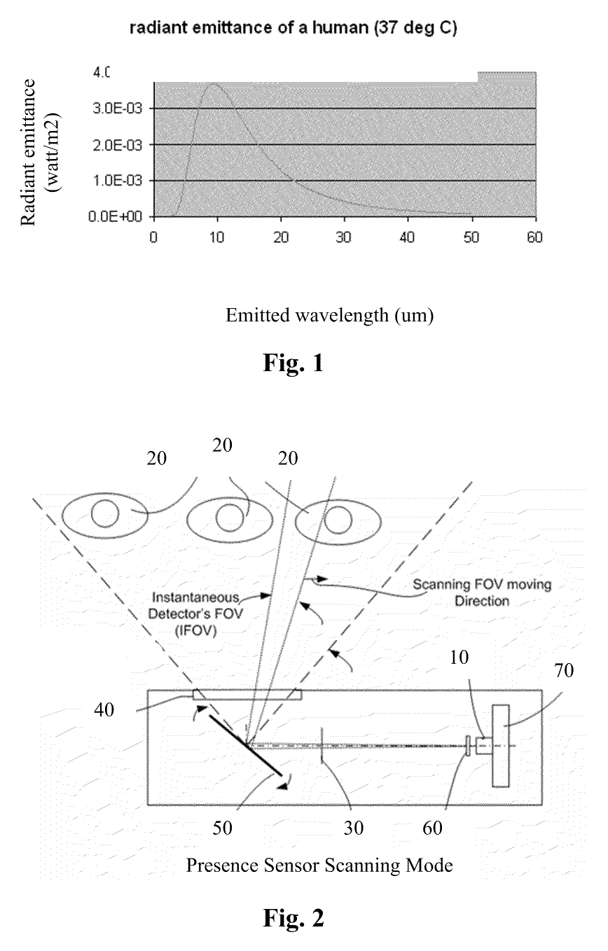

### DETAILED DESCRIPTION OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The present invention relates to a presence detector adapted to detecting and estimating an audience watching television. It is important to be able to detect if at least one person is present in front of the television. This information can be used to determine television programming rating, television advertisement rating. In addition, this information can be useful for saving electricity in the house, as the television, and other appliances in the room such as an air-conditioning unit, can be turned off if nobody is in the room for a predetermined period of time.

The presence detector device can also estimate the number of people present in front of the television, thus providing more accurate information relevant for determining television programs and advertizing rating.

In certain embodiments, the present detector further comprises a communications port for communicating the estimated number of people to a remote facility. The remote facility can further process the received data, and can also decide on the appropriate action to take based on the information received. The communication port can use any available communication links such as Internet, telephone, wireless telephony, wireless data services, cable TV etc.

The term “audience” as referred to herein should be interpreted in a broad sense to encompass, a viewing public, a participating public, passive public, comprising one or more persons.

The presence detector of the invention uses a presence sensor to detect if an audience (people) is present in front of the television. In certain embodiments, it is also possible to estimate how many people are present in front of the television.

The term “presence sensor” as referred herein should be understood in a wide sense, for example, a pyroelectric detector, an ultrasonic transceiver, a thermopile sensor, an imaging camera, an imaging camera with a VMD algorithm, an imaging camera with a face detection algorithm, a photodiode, IR receiver, a microphone, or an electro-optic detector coupled to a light source. It may also be incorporated together in a single chip the camera detector and the processor running the algorithm.

Pyroelectric Detectors

Pyroelectric detectors are thermal detectors. That is, they produce a signal in response to a change in their temperature.

Below a temperature Tc known as the Curie point, ferroelectric materials such as triglycine sulfate (TGS) or Lithium Tantalate, exhibit a large spontaneous electrical polarization. If the temperature of such a material is altered, for example, by incident radiation, the polarization changes. This change in polarization may be observed as an electrical signal if electrodes are placed on opposite faces of a thin slice of the material to form a capacitor. When the polarization changes, the charges induced in the electrodes can be made to produce a voltage across the slice if a the external impedance is comparatively high. The sensor will only produce an electrical output signal when the temperature changes; that is, when the level of incident radiation changes.

This process is independent of the wavelength of the incident radiation and hence pyroelectric sensors have a flat response over a very wide spectral range. The limiting feature on the spectral range is the window material used in the manufacture of the sensor housing. By using different windows materials it is possible to detect radiation at different frequencies.

A pyroelectric detector detects optical radiation in the mid infrared (IR) range. It has a high responsiveness and since it is sensitive to thermal energy it detects a wide range of wavelengths. It contains normally a filter to define the spectral range of interest and a sensing crystal to convert the radiation into electrical signal. The pyroelectric detector may be arranged as a single element detector, a dual element detector in several configurations and also quad elements per detector are available. It is possible to find also pyroelectric detector arrays which may be used for imaging applications. The pyroelectric detector is sensitive to changes in thermal radiation, but it also depends on the frequency response.

In general pyroelectric detectors are used for human motion detection. The most popular and broad known use of these detectors are for volume detection in home security and alarm systems. In that application, the radiation from the human being is perceived by the detector. The amount of power received by the detector depends on the moving velocity of the person. A person emits certain amount of radiation, and when he moves, the detector will collect the amount of radiation emitted by the human body while he is within the field of view (FOV) of the detector according to its velocity (People normally walk at a velocity of 0.5 meters/second and run at about 2 or 3 m/s).

Pyroelectric material develops a voltage difference in response to a temperature change. A single element pyroelectric detector is sensitive to any temperature change so it may also be sensitive to ambient temperature changes, so in order that temperature changes will not be recorded as false alarms it will require compensation for ambient changes. That is the reason that for volume detector applications (and also many other applications) a dual element is used, since it has built in compensation for ambient changes. The compensation is done by connecting the two elements in electrical opposite connection so when both elements detect a temperature change (because of ambient change, for example) then no electrical signal is generated because one element cancels the other. When a human being moves in front of this detector, then the two elements are exposed to a temperature change at a tiny different time, so an electrical signal is generated because of the movement and then a detection alarm is produced.

The pyroelectric sensor is made of a crystalline material that generates a surface electric charge when exposed to heat in form of infrared radiation. When the amount of radiation striking the crystal changes, the amount of charge also changes and can be measured with a sensitive Field Effect Transistor (FET) device built into the pyroelectric sensor. The pyroelectric sensor elements are sensitive to radiation over a wide range so a filter window is added to limit detectable radiation to the 8 to 14 micron, for example. A range which is most sensitive to human body radiation. The typical sensor has two sensing elements connected in a voltage bucking configuration. This arrangement cancels signals caused by vibration, temperature changes and sunlight. A human body passing in front of the pyroelectric sensor will activate first one and then the other element whereas other sources will affect both elements simultaneously and be cancelled. The pyroelectric detector (sensor) described above is mostly used as an infrared motion detector and mainly used for detecting a moving human body. Yet there is no information if the one or more people are moving and if a person is not moving at all he will not be detected. The present invention applies the pyroelectric sensors to estimate how many people are watching a program, and in case that the viewer is not moving at all then the sensor moves instead, having the same detection effect.

In certain embodiments of the present invention the FOV of the different detectors in the array have different FOVs so the extreme detectors have very narrow FOV so people can be detected as entering or exiting the field of regard (area of interest for the audience measurement and counting), and other detectors can be used for counting how many persons are in any sub-area.

Reference is now made to FIG. 2 illustrating an embodiment of a presence detector of the invention. The presence sensor 10, detects the infrared signal coming from the audience 20. A slit 30, limits the field of view of the presence sensor 10 so in every single moment the field of view of the presence sensor 10 is limited to a small instantaneous field of view (IFOV). The size of the slit 30 can vary according to design preference. For example, the slit 30 can be a rectangular opening of 1 centimeter by 2 centimeters. The signal received by the presence sensor 10, enters into the device through a window 40, and is reflected from the mirror 50 and then passes through the slit 30 and through a special filter 60. The mirror 50, rotates so the IFOV also moves in order to scan the audience 20 as shown in FIG. 2 from the left side to the right side in an angle of −45° to +45°. The mirror 50 is coated with a high reflection coating for the MID-IR spectrum (from 4 μm to 15 μm, for example) on both sides so after a rotation of half circle it can reflect the radiation coming from the audience 20 also from the other side. In this example, the angle of interest (the field of view that the mirror 50 scans) is between −45° to +45°. The filter 60 is such that it allows transmitting only spectral radiation corresponding to the typical radiation that is emitted by the human body within the spectrum mentioned above. The emission spectrum of an incandescent lamp, which is a common light source, emits most of its radiation in much lower wavelengths, so if a filter 60 blocking lower wavelengths is not used then the presence sensor 10 will detect also the lamp and not only the human body.

The electronics card 70, translates the signal received in the presence sensor 10 to a signal representing the occupancy of the audience 20 within the angle of interest. The electronics card 70 comprises also a processor and communications means in order to integrate the information about the presence of the audience 20 the channel which is being watched and communicates it to a distant location.

The electronics card 70 also synchronizes between the mirror 50 rotation and the timing of light collection by the presence sensor 10, in such a way that once the line of sight moves an angle which is equal or less than the instantaneous FOV then resets the presence sensor 10 if necessary and reactivates it again to be ready to collect again the reflected radiation from the human body in the presence sensor 10 and no “holes” are formed in scanning the audience 20.

Ultrasonic Sensors

Another type of presence sensors 10 that may be used for the detection of an audience 20 are ultrasonic (acoustic) detectors such as ultrasound detectors or transceiver.

These detectors may consist of a single transceiver (transmitter and receiver) or a dual sensor (one for transmission and the other for receiving).

The transmitter emits a signal and by measuring the time it takes to the signal to come back, it can calculate the distance of the object from the sensor. In our case the sensor may be located in the TV, on the TV panel, or on the set-top box and the object is the audience 20.

When nobody is present in front of the TV the ultrasonic sensor will detect a distance which corresponds to the distant wall or furniture. When a person enters into the field of view of the ultrasonic sensor, then the ultrasonic sensor detects a different temporal distance and it can be deducted that a person is present. When the person moves, a change in the integral distance detected will appear. If the FOV of the ultrasonic sensor is small, it is possible to scan with the ultrasonic sensor over a larger area (compared to the sensor's FOV) and receive a mapping of objects' distance from the sensor. In that way, when a person enters into the area a change in the mapping will describe where people entered and also where they are seated.

Thermopile Sensors

Thermopile sensors measure the temperature of an object based on the radiation energy emitted by the object and collected by the thermopile sensor. When there is no audience 20 in front of the thermopile sensor, the thermopile sensor reports a similar temperature to its ambient temperature sensor. When a person is present then the measured temperature raises showing a higher temperature than the ambient temperature. If, for example, a person leaves the place when an advertising starts, then the thermopile sensor will detect a decrease in the temperature showing again the similar temperature as the ambient. According to the temperature measured it is possible within the FOV of the thermopile sensor to calibrate the additional contribution of each person to the object temperature level that the thermopile sensor shows. It is possible also to use a small FOV angle sensor (that is more sensitive) and by scanning the area in a wider FOV. Using a static wide FOV thermopile sensor is also an alternative, though it may be less sensitive. For example, one can choose a 15 degree FOV thermopile sensor for the sensitive and scanning method or a 60 degree FOV thermopile sensor for the static method (an example of such a sensor is the Perkin Elmer a2TPMI 336 OAA 060 IRA). It is also possible instead of scanning to put several thermopile sensors in an array one to the side of the other and thus receiving a higher FOV.

The signal processing coming from the thermopile sensor can be done using a simple processor (for example, an 8051 processor). This processor will receive the signal and according to a logical sequence of events detected by the thermopile sensor.

It is possible also to combine a plurality of presence sensors 10 of different types in a single presence detector. For example, by using both a thermopile sensor and a pyroelectric detector it is possible to obtain information about the movement of the audience 20 and the presence of the audience 20 and consequently, to deliver the advertisement according to the audience 20 behavior. For example, if the person is sleeping the thermopile will detect his presence but the pyroelectric detector will not detect movements for a long time (for example, 15 minutes). This information may be used for saving energy, for example, by turning off the TV. And in the case that the person is present and awake it may be a good moment to deliver a commercial clip. If the sensors detect that the person is leaving the area during the advertisement then this information will be transmitted to the advertiser as an additional field of report that is evaluated by a central server as part of the viewing habits and television rating data analysis services.

In general, the presence detector can use any combination of different presence sensors 10 available in the industry.

VMD (Video Motion Detection) Method

There are many VMD algorithms for performing video motion detection and in special in the security area for detecting moving people or objects.

to the presence detector can use the same VMD algorithms to detect the movements of a person or detect body par movements such as hands, head, legs etc. A person, even watching TV, cannot stay without moving any body part for an extended period of time.

The basic VMD algorithm works by capturing two consecutive frames and by subtracting one from the other. If there is a movement then the subtraction will not be zero and this non zero part of the image will be detected as a movement. It is possible then to detect where in the FOV the movement happens and then image processing software can track each person entering the FOV and exiting it. Thus the number of people in front of the TV (or any other device) can be known. The VMD module can be integrated into a TV set, a set-top box, air conditioning unit etc.

The module may include the imaging sensor or both the imaging sensor and a CPU for making the calculations (such a CPU may be a DSP, arm, the same imager with a SOC (system on chip) or a simple 8051 controller family for example or similar or more advanced controllers).

The light source for the application of the VMD may be the room light, or at dark conditions the light from the TV itself or for more reliable results by adding an IR light source.

Face Detection

Instead of using a VMD algorithm, the detection may be done by using a face detection algorithm. Such an algorithm is adapted to detect special features that are common in faces and by looking for the combination of several such features it is possible to decide that a face is present in the scene in front of the TV.

In certain embodiments of the present invention, the presence detector is used to turn off electrical devices when an audience 20 is not detected for a predetermined period of time. Examples of such electrical devices include but are not limited to: television sets, air conditioning units, heating systems etc. In the case of an air conditioning unit, the presence detector can be connected to the air conditioning unit and control in a similar way the operation of the air conditioning unit, turning it off when no people are detected for a given period of time.

The existing way of operation for the air conditioning unit saving energy is by using a volume detector based on a single pyroelectric sensor. The drawback of this method is that if the person does not move (for example, sleeping or reading a book) then the module will stop the air conditioning unit by directly turning the power off, and then when the person moves again it activates the air conditioning unit again.

By using the presence detector of the invention it is possible to detect people in a room even when the people are not moving.

An additional advantage of the invention is that the power off/on is not done from via the power switch on the wall but by activating the unit's remote control. In certain embodiments of the present invention, a mirror 50 is placed in front of the presence sensor 10 (for example, a Pyroelectric detector), and the presence sensor 10 “looks” through a very narrow slit 30. When the mirror 50 rotates the presence sensor 10 detects different angles in the field of view, and when this angle of view identifies a person, then the person is detected because of the moving angle of view. So in this way, instead of the person being required to move in order to be detected, the presence sensor 10 or more accurately the presence sensor's 10 FOV is moving and when a person appears suddenly in the FOV a change in the radiation received by the presence sensor 10 (such as a pyroelectric detector) is obtained and then a detection signal is generated from the presence sensor 10.

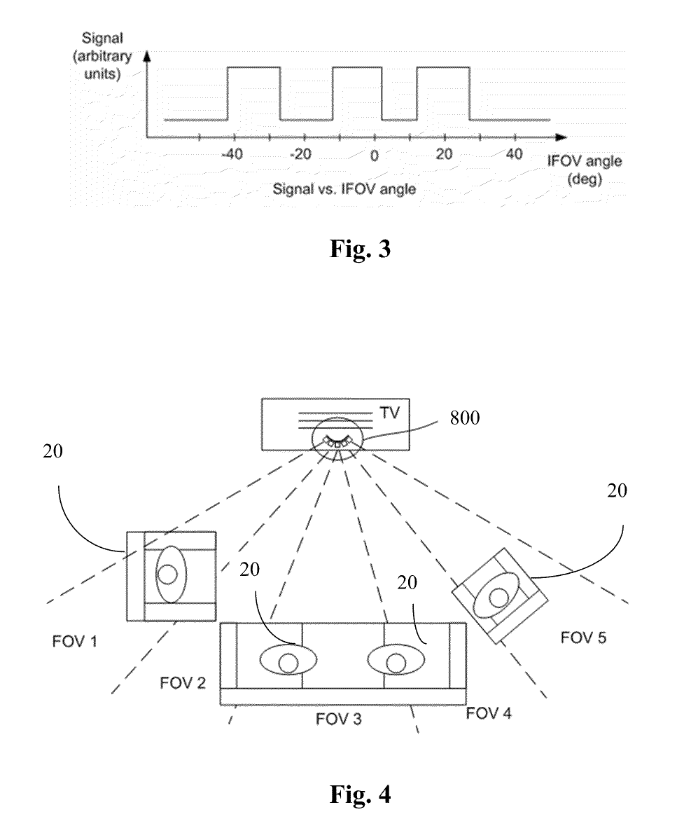

FIG. 3 is a graph of the signal received in the presence sensor 10 after the mirror 50 has rotated by 180°. Once the mirror 50 completes this half circle rotation, it starts reflecting again the radiation coming from the left side to the right side of the angle of interest. In the graph, for example, the scanning starts from −45° to +45° and the first person in the audience 20 appears at about −41° and it is in front of the IFOV of the detector up to about −28°, and so on with the other two members of the audience 20 as shown.

In certain embodiments of the present invention the pyroelectric detectors are arranged in an array arrangement with different field of view (FOV) for each other. Each detector in its FOV detects a person moving when entering or exiting the FOV.

In certain embodiments of the invention, an estimation of the number of people viewing a program can be done by counting how many persons emits heat to several detectors.

In some cases, there is no certainty that the detected audience 20 is actively watching a program on television, but nevertheless it is important to know that some people are present in front or at the area of the television. For example, if we use a motion detector or a volume detector 10, once the pyroelectric detector 10 detects a motion, a signal is generated informing that at least one person is detected If many people are moving at the same time, then when using a single motion/volume detector it is not possible to know how many people are actually out there.

Reference is now made to FIG. 4 illustrating an embodiment of a presence detector comprising multiple presence sensors 10 with equal field of view (FOV). In order to increase the accuracy of the device for detecting several people, several presence sensors 10 can be located, for example, in a matrix 800 (series) of presence sensors 10 where each presence sensor 10 has a separate field of view. For example, 6 presence sensors 10 with a field of view of 15 degrees for each one to create a total of 90 degrees. If for, example, two presence sensors 10 create a signal simultaneously, it means that two people are at the corresponding fields of view, assuming the fields of view are far enough to eliminate the option that two fields of views cover one person. If these two same presence sensors 10 detect a signal sequentially, then we may conclude that it corresponds only to single person that was moving. In any case each person is detected as long as being on the move.

The size of the field of view of each presence sensor 10, is determined by its corresponding slit 30 (not shown). Preferably, a filter 60 is placed before each presence sensor 10 in order to allow transmitting only spectral radiation corresponding to the typical radiation that is emitted by the human body. The use of this filter 60 is optional.

In the example shown at FIG. 4, there are 4 people in front of the television but according to the field of view of the presence sensors 10, only 3 people 20 will be detected since two people 20 are captured in FOV3 but are counted as a single detection. This is a good estimation. Increasing the number of presence sensors 10 will increase the accuracy of the estimation.

In the event that the people in the room are not moving, the whole set 800 of presence sensors 10 may move slightly axially or rotationally and create a signal at all the presence sensors 10 which detect human heat change. The rotation can be done by an electric motor or step motor or a solenoid that moves the matrix forwards and back slightly enough to activate the motion/volume detectors 10 matrix.

As described above, the invention uses the technology of presence sensor 10 such as a pyroelectric detector 10 which normally is used in current motion/volume detectors to create a different product of people presence counting detector. The people in the audience 20 need not move in order to be detected, since the whole matrix 800 or series moves periodically. In the present embodiment the matrix/series 800 may be located on the television or set top box or in front of the audience 20.

A microprocessor collects the signal of all the presence sensors 10 and estimates according to motion and sleeping behavior of audiences 20.

A rotation of one presence sensor 10 around an axis can produce multiple signals. Counting the number of signals may infer to the number of people 20 in the field of view that was scanned by the rotation.

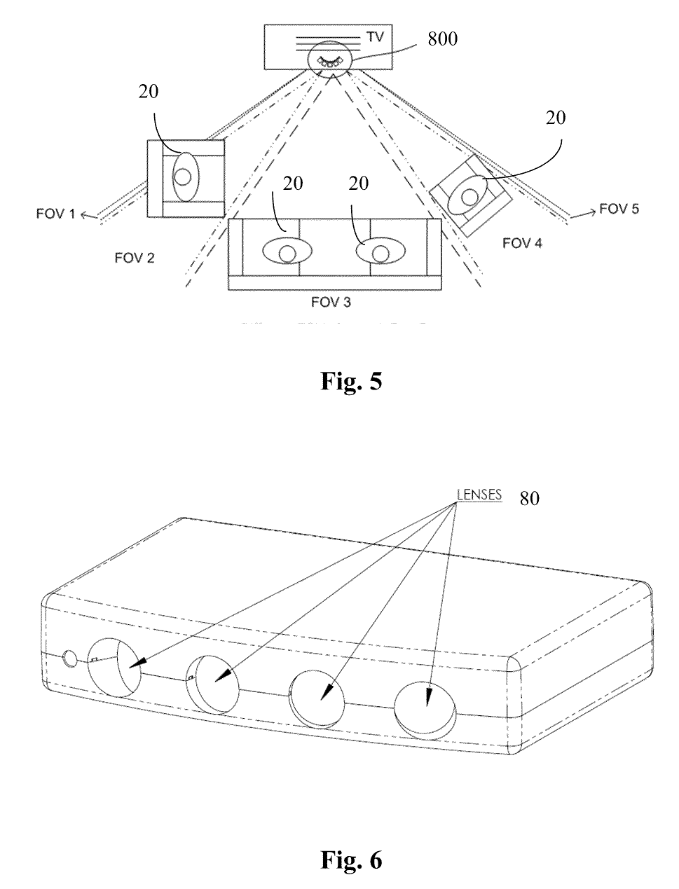

FIG. 5 illustrates an embodiment of a presence detector comprising multiple presence sensors 10 with variable size field of views (FOV). The angles of each field of view can be different, for example, the two external fields of views 1 and 5 for example in FIG. 5 may be very narrow such that once there is a detection in those fields of view it means that someone cross the interesting area and remains inside. According to the order of the presence sensors 10 signal generation, it can be estimated where the person 20 is actually located. Since those fields of view (1 & 5) are very narrow the generation of the signals will be short enough during normal motion or walking of a person 20 so only one person 20 can be captured in such a narrow FOV.

Pyroelectric sensors (volume heat detectors in their most common use) are a popular way to detect human presence, and they are frequently used in many applications such as security alarm systems. A pyroelectric detector can detect changes in body position but it cannot not immobile bodies. In these applications, typically a single pyroelectric sensor is used provided by a Fresnel multilens and a person moving in a room can be detected only if his movement is wide enough and a large area of his body is in the FOV of the pyroelectric detector. Small movements of a person watching TV, for example, will be rarely detected by such a detector. A device built around such a detector will not be sensitive enough to be used in applications such as automatically turning off a television set if nobody is watching it. Such an application should turn off the television only if it is certain that nobody is watching it. In order to detect people in a targeted area, for example, sitting on a sofa in front of a television, a standard pyroelectric (volume) detector is not sensitive enough to operate reliably and efficiently since people watching television do not tend to move very much and thus they most likely will not be detected by a single pyroelectric detector. A pyroelectric detector will not detect small movements like changing gaze orientation, adjusting a sitting position or small hands movements. A pyroelectric detector with a large FOV will need large movements, for example, moving half size of a body in order to register a presence.

In certain embodiments of the present invention, a combination of several pyroelectric detectors is applied. FIG. 6 shows an embodiment of a presence detector with 4 pyroelectric detectors wherein each pyroelectric detector is coupled to a lens 80 and has a very small field of view, for example, 10-20 degrees and their line of sight is directed toward the upper part of the viewers' body, at a height of about one meter. The detection will be optimal up to about 6 meters, though a presence can also be detected at bigger distances too. A diffractive lens 80 is advantageous to use because it is relatively flat and cost effective. In such a narrow field of view, it is possible to multiply the amount of heat collected into the pyroelectric sensor and thus effectively being much more sensitive to very slight movements of a person watching television, for example. In certain embodiments of the present invention 4 or 5 pyroelectric detectors are used in a single presence detector device.

In a volume/motion detector or infrared transducer the single pyroelectric detector is provided with a large multi-lens Fresnel in which each direction uses a portion of the multi-lens and is able to collect small amounts of heat from every location. In this solution each pyroelectric detector is provided with a single lens which is larger that any of the lenses on the Fresnel multi-lens and is also much smaller than the Fresnel dimensions. A standard Fresnel multilens used for alarm systems is about 40×30 mm in size and may be composed from 20 to 40 lenses. Each one of these lenses is typically less than 8 mm in size. In order to enlarge the total field of view (for example to 100 degrees) between 4 and 5 pyroelectric sensors are required with or without overlapping. Each pyroelectric sensor coupled to its own lens 80 can cover a circular FOV of about 10-20 degrees. The sensors can be arranged in a line of sight orientation covering together (according to the number of detectors) a higher azimutal FOV, for example, 100 degrees. In a distance of up to 6 meters there is no need for overlapping of the different FOVs, since a person's body will enter into the FOV of some detectors anyway. Such array detector covers some angle of view and the distance will be limited more by the formation of ‘holes’ in the FOV than by the sensitivity of each detector. If the ‘hole’ between two sensors is 5 degrees, then at a distance of 6 meters it will be about 0.5 meter, and in order to fail to detect a person at that distance, the person should sit exactly with his entire body inside this 0.5 meters ‘hole’. Naturally, the problem of “holes” between two sensors can be overcome if the number of sensors used is increased and the sensors are made to overlap.

Adding standard signal processing algorithms to the invention allows overcome noise, and enables to detect if there is someone at all in front of the television or not.

For example, a typical lens 80 in the present invention is about 8 mm diameter, which allow to receive a low profile device, and to be installed inside TVs and STBs. If using a Fresnel lens, the profile will be dictated at least by its lens so a minimal profile may be about 30 mm. Since the invention uses small diameter lenses 80 then the result will be a small profile device.

In such a manner the pyroelectric detector can cover an area of 20 degrees in elevation and 100 degrees azimutal, which in a distance of 3-4 meters is enough to detect any person in the sofa even if that person is hardly moving or even sleeping.

The pyroelectric sensors may be arranged in a line or circular manner or any geometrical requirement without changing the field of view.

The pyroelectric sensors are controlled together via one or more microprocessors (translators) and according to levels of signal detected in every pyroelectric sensor it can be estimated if a person or more is in front the unit.

Accurately estimating the number of people in an audience 20 can have great commercial implications for different applications such as estimating the popularity of television programs, how many people watch an advertisement, how many people enter a shopping mall, how many people visited an exposition or a conference, how many people entered a commercial location etc.

In certain embodiments of the present invention, the presence detector detects the content of the television program the audience 20 is watching. For example, the presence detector can connect to a television set-top box receiving TV channels via satellite, cable or the Internet in order to determine which channel is broadcast on the television set at each moment. Data received directly or indirectly from the TV service operator (typically cable or satellite nowadays, and through the Internet in the future) lists at every given moment the content broadcast on each channel. The content is typically looked at as being either a commercial advertisement or a television program.

In certain embodiments of the present invention, the price of commercial advertisement is determined in relation to the audience 20 reports provided by the presence detector of the invention. The more people watch an advertisement the higher it can be priced. Advertisements can thus be priced in real-time according to the number of people actually watching at a given moment. Alternatively, the audience 20 actually measured can be looked at as a sample representing the real number of people watching at a given moment.

In certain embodiments of the present invention, each television (or household) receives individual, personalized commercial advertisements according to measured audience 20 ratings for each specific television (or household) and according to additional parameters such as socio-demographic data, personal preferences, previously recorded TV watching habits etc. The invention thus allows targeting of custom advertisements for each television set and/or household.

The presence detector can also be used for the timing of placing advertisements. For example, it can be decided that an advertisement is not displayed unless at least one person is detected in front of the television.

In certain embodiments of the present invention, each household is allocated a group of advertisements. Each advertisement of that group is only displayed when an audience 20 is identified as watching the television set. In this way, it can be guaranteed to the advertiser that the advertisement has actually been seen by an audience 20 as opposed to cases where people take a bathroom break when the advertisements begin or they change channels while waiting for the program to resume.

In certain embodiments, a presence detector is installed or integrated, for example, in a set-top box or in the TV panel itself, in a display screen, an air conditioning unit, a “media center” or in any place that can be seen by the audience 20.

Many television sets remain active even though nobody is in front of the television. It is possible to use the presence detector of the invention to determine if nobody is watching the television, and then turn the television off after a predetermined period of time thus saving electricity and increasing the life of the screen.

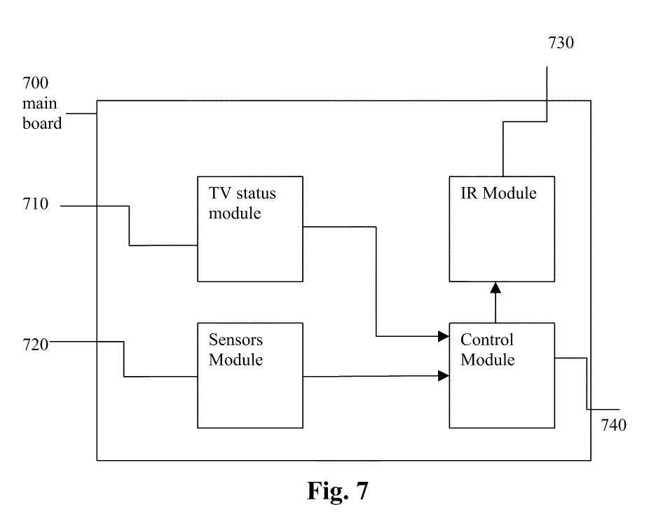

In the case that the device doesn't detect any person for a period of time for example 5, 10, 15 minutes (or any other predetermined time) than it can turn off the television. The device contains four modules that may be located on one board as specified in FIG. 7:

1) IR module 730—has the ability to learn IR signals from remote control. The IR transceiver can learn several IR channels with modulation around 38 KHZ for example. The learning process may be performed manually by push buttons. During the installation of the device each button on the remote control is pressed and the device receives it and store it in its memory so it can later simulate the TV remote control operation
2) Presence Sensors Module 720—the board 700 supports several types of sensors: pyroelectric, thermopiles, acoustic sensors, face detection, VMD detectors.
3) Control module 740—this module is responsible for reading presence sensors, running a state machine, and turning on the IR module for turning off the television. Optionally, the information about the audience 20 in front the television may be transmitted by communication protocols to any remote location or WEB site.
4) TV status module 710—it may include various options such as: a photodiode that is looking on the TV screen. If there is light above some specific threshold from the screen then TV is on. There are many other options for detecting if the TV is on. If we sample the audio in signal and using a microphone on the device board than by comparing the signal and applying correlation than if the TV is not muted we can know that the TV is on. Another option is to sample the current that enter the TV, when the TV is on than the current is much higher than when the TV is off. It can be done also by a magnetic loop.

Although the invention has been described in detail, nevertheless changes and modifications, which do not depart from the teachings of the present invention, will be evident to those skilled in the art. Such changes and modifications are deemed to come within the purview of the present invention and the appended claims.

1. A presence detector for detecting an audience, comprising:
a plurality of pyroelectric detectors for capturing thermal signals emitted by the audience;
a plurality of lenses, wherein each lens is positioned in front of a pyroelectric detector; and
one or more microprocessors connected to said plurality of pyroelectric sensors for translating thermal signals created by the plurality of pyroelectric detectors to data signals representing the estimated number of people in the audience.

2. A presence detector according to claim 1, wherein the line of sight of said plurality of pyroelectric detectors is directed toward the upper part of a person's body, at a height of about one meter above the ground.

3. A presence detector according to claim 1, wherein the field of view of each pyroelectric detector is between 10 and 20 degrees.

4. A presence detector according to claim 1, wherein said plurality of lenses are diffractive lenses.

5. A presence detector according to claim 1, wherein each lens of said plurality of lenses has a diameter of about 8 mm.

6. A presence detector according to claim 1, wherein said audience is an audience watching television and the content displayed on the television is selected according to the estimated number of people detected in the audience.

7. A presence detector according to claim 6, wherein said content is an advertisement.

8. A presence detector according to claim 7, wherein said advertisement is priced according to the audience measured.

9. A presence detector according to claim 7, wherein an advertisement is displayed only if an audience is detected.

10. A presence detector according to claim 1, wherein said audience is an audience watching television and the television's screen is turned off after no audience is detected for predetermined period of time.

11. A presence detector according to claim 1, wherein an air-conditioning unit turned off after no audience is detected for a predetermined period of time.

12. A presence detector according to claim 1, integrated into a television set, a set-top unit or any audio-visual unit.

13. A presence detector according to claim 1, wherein the presence detector comprises an electronic circuit that finds out if a television is turned on.

14. A presence detector for detecting and estimating an audience watching television, comprising:
one or more presence sensors adapted to capturing sound signals, infrared signals, electromagnetic signals or optical signals emitted by or reflected from the audience, wherein said one or more presence sensors comprise: a pyroelectric detector, an ultrasonic transceiver, a thermopile sensor, an imaging camera, an imaging camera with a VMD algorithm, an imaging camera with a face detection algorithm, a photodiode, IR receiver, or an electro-optic detector coupled to a light source; and
a translator connected to said one or more presence sensors adapted to translating output signals created by the one or more presence sensors to data signals representing the estimated number of people in the audience.

15. A presence detector according to claim 14, wherein said photodiode or IR receiver detects signals emitted from any remote control operated by the audience.

16. A presence detector according to claim 14 further comprising:
a slit;
a filter; and
a rotating motor.

17. A presence detector according to claim 16, further comprising a mirror wherein said mirror rotates in order to scan a large field of view.

18. A presence detector according to claim 17, wherein said mirror is coated on both sides with high reflection coating for the mid-IR spectrum from 4 micron to 20 micron.

19. A method for detecting and estimating an audience watching television, comprising the steps of:
capturing signals emitted by or reflected from the audience by
a presence sensor according to claim 1; and
translating said captured signals to a data signals representing
the estimated number of people in the audience.

20. An advertising method for sending commercial advertisements to an audience in front of a television set, the method comprising the steps of:
(i) detecting the presence of at least one viewer in front of said television set via the presence detector of claim 1; and
(ii) sending an advertisement to said television set only when said at least one viewer is detected.
